(19) United States
(12) Patent Application Publication
(10) Pub. No.: US 2023/0078939 A1
(43) Pub. Date: Mar. 16, 2023

(54) TOY CONSTRACTION ELEMENT DECORATION

(71) Applicant: GIFTEC,LTD, Gaithersburg, MD (US)

(72) Inventor: Jack Hall, Gaithersburg, MD (US)

(21) Appl. No.: 17/472,602

(22) Filed: Sep. 11, 2021

(51) Int. Cl. A63H 23/14; A63H 23/16; A63H 33/26; A63H 23/00; A63H 5/00

(52) U.S. Cl. CPC A63H 23/14; A63H 23/16; A63H 33/26; A63H 23/005; A63H 5/00

(57) ABSTRACT

A toy atomization device construction elements decoration comprises a base 1. An opening water tank 2 is integrated into the humidifier base 1. A water inlet 8 is opening on the upper surface of the casing 111. The inside of the base 1 is combined with the water tank 2 and an atomizing chamber 3.

### FIELD OF THE INVENTION

This invention relates to a toy construction element decoration, comprising a water fountain device, Atomization device, dialogue system, voice device, magnetic device and much more fun device.

### BACKGROUND OF THE INVENTION

The conventional toy construction elements mostly serve the purpose of toys, and are rarely decorative and functional. The inventor of the present invention also has the following eighteen U.S. patents granted: U.S. Pat. Nos. 5,078,386; 5,088,373; 5,070,753; 5,286,535; 4,890,828; 5,203,743; 4,987,787; 6,978,564, 4,939,944; 5,448,007; 5,081,899; 8,807,539, 9,157,644, 8,371,559, 8,146,892, 8,025,270, 9,151,509 and 5,163,878. The inventor created these patents into toys construction elements business, trying to help childrens have more fun and more happiness.

### SUMMARY OF THE INVENTION

The present invention relates to a toy construction element decoration, not only a construction element toy, but also has more functionality and more fun.

### BRIEF DESCRIPTION OF THE DRAWINGS

FIG. 1 a-d each show a prior art toy building brick;

FIG. 2 illustrates an exploded view of the second embodiment of the present invention;

FIG. 3 illustrates an exploded view of the third embodiment of the present invention;

FIG. 4 illustrates an exploded view of the fourth embodiment of the present invention;

FIG. 5 illustrates an exploded view of the fifth embodiment of the present invention.

FIG. 6 illustrates an exploded view of the sixth embodiment of the present invention.

FIG. 7 illustrates an exploded view of the seventh embodiment of the present invention.

FIGS. 8 and 9 illustrates two moving mechanisms used with a decoration shown in FIG. 10, this structure can also be used with the structures of FIGS. 1-48;

FIG. 10 illustrates another decoration that can be attached to the humidifier, this structure can also be used with the structures of FIGS. 1-48;

FIGS. 11, 12, . . . , 25, and 26 illustrate a first, second, . . . , fifteenth, and sixteenth subassembly, respectively, than can be used with the embodiments shown in FIGS. 1-7 and 27-48;

FIG. 27 is a longitudinal sectional view of a support seat of the embodiments of the present invention, having a single water wheel, in which the structures of FIGS. 1-26, 28-48 can be used with this structure;

FIG. 28 is a longitudinal sectional view of a water exit valve, this structure can also be used with the structures of FIGS. 1-7, 27, 29-48;

FIG. 29 is an extended mechanism which can be used with the structures of FIGS. 1-28, and 30-48;

FIG. 30 is another extended mechanism which can be used with the structures of FIGS. 1-29, and 31-48;

FIG. 31 is another extended mechanism which can be used with the structures of FIGS. 1-30, and 34-48;

FIG. 32 is yet another extended mechanism which can be used with the structures of FIGS. 1-31; and 34-48.

FIG. 33 is yet another extended mechanism which can be used with the structures of FIG. 1-32. 34-48

FIG. 34 illustrates an exploded view of the eight embodiment of the present invention; in which the structures of FIGS. 1-33, 40-48, can also be used with this embodiment;

FIG. 35 illustrates an exploded view of the nine embodiment of the present invention; in which the structures of FIGS. 1-33, 40-48, can also be used with this embodiment;

FIG. 36 illustrates an exploded view of the ten embodiment of the present invention; in which the structures of FIGS. 1-33, 40-48, can also be used with this embodiment;

FIG. 37 illustrates an exploded view of the eleven embodiment of the present invention; in which the structures of FIGS. 1-33, 40-48, can also be used with this embodiment;

FIG. 38 illustrates an exploded view of the twelve embodiment of the present invention with some structures (e.g., for example a base seat, a base plate, and relevant parts) not shown in this figure;

FIG. 39 depicts an automatic safety device for the humidifier; in which the structures of FIGS. 1-7, 27, 31-48, can also be used with this embodiment;

FIG. 40 depicts a ultrasonic device for transforming water into vapor. in which the structures of FIGS. 1-7, 27, 31-48, can also be used with this embodiment;

FIG. 41 illustrates an exploded view of the embodiment A of the present invention, in which the structures of FIGS. 8-33, can also be used with this embodiment;

FIG. 42 illustrates an exploded view of the embodiment B of the present invention, in which the structures of FIGS. 8-33, can also be used with this embodiment;

FIG. 43 illustrates an exploded view of the embodiment C of the present invention, in which the structures of FIGS. 8-33, can also be used with this embodiment;

FIG. 44 is a longitudinal sectional view of a water exit valve, this structure can also be used with the structures of FIGS. 2-7, 34-38; 44-48

FIG. 45 illustrates an embodiment of the present invention, in which the structures of FIGS. 8-233 can also be used with this embodiment;

FIG. 46 illustrates another embodiment of the present invention, in which the structures of FIGS. 8-33 can also be used with this embodiment;

FIG. 47 illustrates yet another embodiment of the present invention, in which the structures of FIGS. 8-33 can also be used with this embodiment;

FIG. 48 illustrates a perspective view of embodiment of the present invention in which the structures of FIGS. 8-33 can also be used with this embodiment;

### DETAILED DESCRIPTION OF THE INVENTION

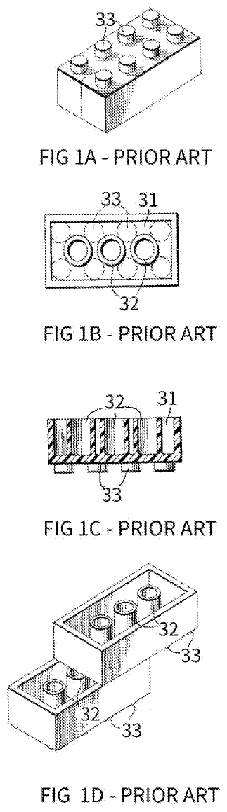

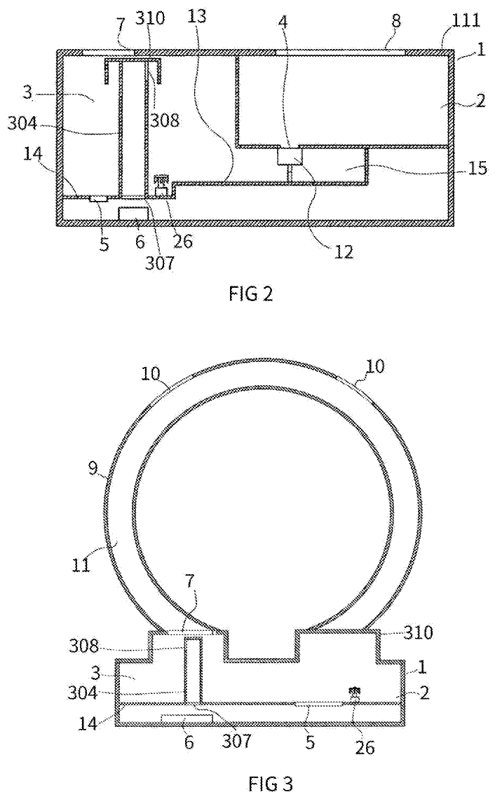

FIG. 1A-1D each show a prior art toy building brick with coupling studs 33 on their top surface and a cavity 31 extending into the brick from the bottom. FIG. 1A shows the top side of a toy building brick, FIG. 1B shows the bottom side of the same toy building brick. FIG. 1C shows a section of the building brick. The cavity has a tube 32, and coupling studs of another brick can be received in the cavity in a frictional engagement as FIG. 1D, The building bricks shown in the FIGS. may have this known type of coupling means in the form of cooperating studs and cavities. However, other types of coupling means may also be used. The coupling studs are arranged in a square planar grid, i.e. defining orthogonal directions along which sequences of coupling studs are arranged. Generally, such an arrangement of coupling elements allows the toy bricks to be interconnected in a discrete number of orientations relative two each other, in particular at right angles with respect to each other. It will be appreciated that other geometric arrangements of coupling elements may result in different orientational constraints. For example, the coupling elements may be arranged in a triangular, regular grid allowing a building element to be placed on another building element in three different orientations. Any kind of design building bricks can be engaged in FIG. 2 to FIG. 48 in this invention.

As shown in FIG. 2, A toy construction element decoration comprises a base 1. An opening water tank 2 is integrated into the humidifier base 1. A water inlet 8 is opening on the upper surface of the casing 111. The inside of the base 1 is combined with the water tank 2 and an atomizing chamber 3. The atomizing chamber 3 is composed of a water sub-tank 14. The water tank 2 with the atomizing chamber 3 and sub-water tank 14 are provided with the base 1. A water level control board 13 and the bottom of the water tank 2 form a first chamber 15. A water opening 4 is provided at the bottom of the water tank 2. A water level control board 13 is provided with a water exit valve 12 corresponding to the water opening 4. The water exit valve 12 is provided for controlling the flow rate and on/off of the water flow downward from the water tank 2 through the water sub-tank 14. On the water sub-tank 14 is provided with the atomization device 5 and an automatic breaker 26. The atomization device 5 can be an ultrasonic device or a heater or filter or a water absorption strip or Absorbent tube (not shown in this FIG), can be made by any kind of material to easily suck water, working with ultrasonic device 305 for transforming water into vapor. A fan 6 is installed on the base 1. A first vapor opening 7 is provided on the upper surface of the casing 111. An air guide 304 with an air opening 308 and an air inlet 307 is provided on the water sub-tank 14. When the humidifier is turned on, the opening water tank 2 is filled with water, the water can flow through the water opening 4 into the water sub-tank 14. The atomization device 5 generates vapor with an ultrasonic device or a heater. The fan 6 on the bottom of the base 1, sucks air from the space under the fan 6 upwardly, forces the air to go through the first air guide tube 304 from air inlet 307, toward the air opening 308 to exit through the first vapor opening 7. The first air guide tube 304 is connected with water sub-tank 14. A protected cover 310 covers the air opening 308 to avoid the water flow into the air opening 308 when the ultrasonic device generates the vapor. FIGS. 2-7.10.31-33 base 1 or water tank 2 can be composed of toy construction elements, the toy construction elements comprising couplings releasably interconnecting the toy construction elements.

FIG. 3 shows the toy construction element decoration base 1 is disposed with a layer of a first ornament 9. The first ornament 9 is annular and connected outside of the base 1. Inside the first ornament 9 is disposed with a second air guide tube 11, which is connected with the first vapor opening 7 and which is used for a second vapor opening 10 that is disposed on the first ornament 9. The fan 6 sucks air from the base 1 forces the air to go through the first air guide tube 304 from air inlet 307, toward the air opening 308 to exit through the first vapor opening 7 and go through the second air guide tube 11, toward the second vapor opening 10. The second air guide tube 11 should be longer than the height of the base 1, or the second vapor opening 10 should be higher than the first vapor opening 7 by at least half or same height of the casing 111 to keep enough vapor for best effect and make the whole design more valuable. The cover 310 can be combined with the first ornament 9, which includes the second air guide tube 11, the second vapor opening 10, and the first vapor opening 7, which are all shared in one component. It is easy to take out cover 310 to refill water or for cleaning. The water tank 2 is combined with water sub-tank 14 to form a single component. FIG. 1, FIG. 2 FIGS. 8 to 33 can be used in this embodiment.

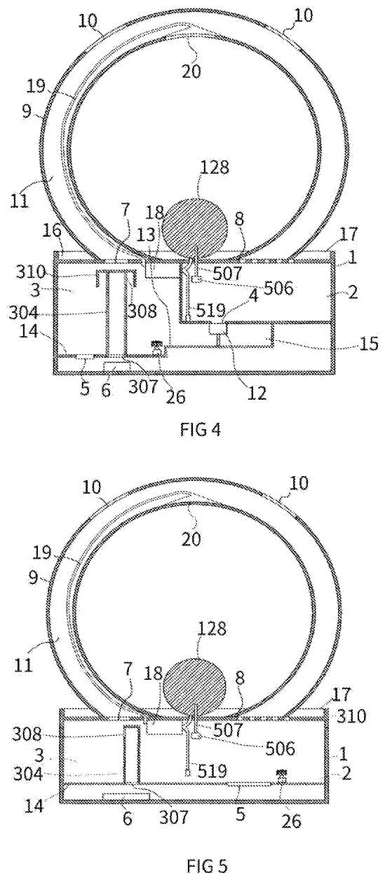

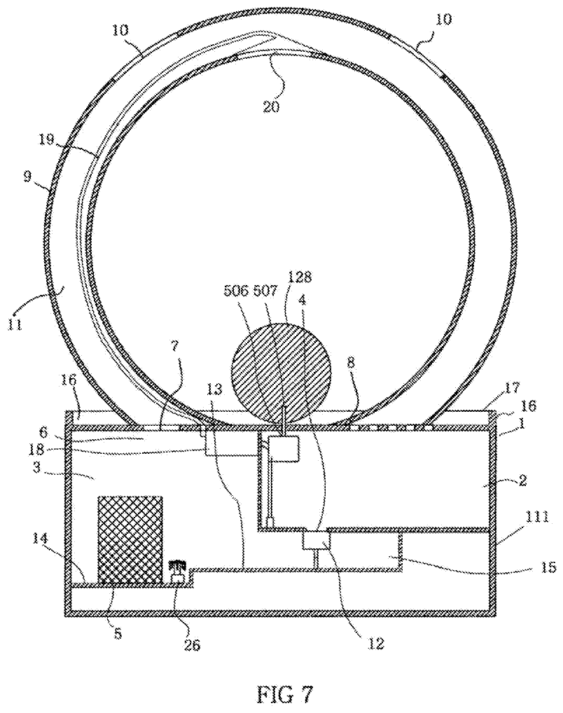

FIG. 4, FIG. 5 and FIG. 7 shows the upper surface of the casing 111 is provided with a water barrier 16. The water barrier 16 and the upper surface of the casing 111 form a second water sub-tank 17. The second water sub-tank 17 is connected with the water tank 2 via the water inlet 8. The second water sub-tank 17 will help create more capacity for water tank 2 and also make it easy to refill water. The second sub-tank 17 can be integrated with the water tank 2 and use the same water inlet 8. The humidifier base 1 is provided with a water pump 18. One end of the water pump 18 is connected with the water tank 2 through the water outlet pipe 519 and the other end is connected with a first water outlet 20 via a first water outlet pipe 19 in the first ornament 9. When water is pumped through the first water outlet pipe 19 and flows out of the first water outlet 20, the water will flow back to the water tank 2 via the water inlet 8. The water pump 18 can suck water through the second water outlet pipe 519 to move the second ornament 128. The water flows out of the first water outlet 20 can also move the second ornament 128. The first water outlet 20 should be higher than the first vapor opening 7 or water inlet 8 by more than half or same height of the casing 111 to make vapor and anion from the waterfall. A power source 506 can also be disposed of on the humidifier base 1. The power source 506 drives a shaft 507 to move the second ornament 128 or can be used with an extension mechanism. The cover 310 can be combined with the first ornament 9, which includes the second air guide tube 11, the second vapor opening 10, and the first vapor opening 7, which are all shared in one component. The cover 310 can also be combined with the first ornament 9, which includes the first water outlet pipe 19, and the first water outlet 20 which are all shared in one component. FIG. 1, FIG. 2 FIGS. 8 to 33 can be used in this embodiment.

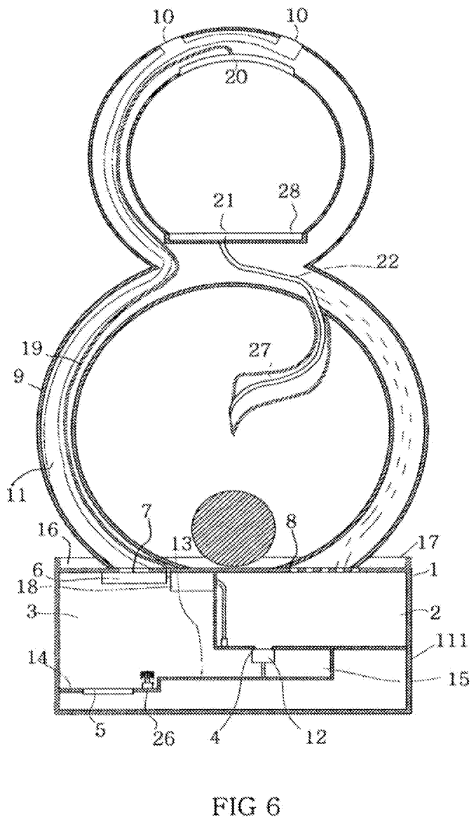

FIG. 6 shows first ornament 9 is in a two-layer structure, which is in an 8-shaped structure composed of two annular structures. The first water outlet 20 is at the lower end of the upper annular structure and connected with the water pump 18 via the water outlet pipe 19. A third water sub-tank 28 is disposed beneath the first water outlet 20 where the lower annular structure is located. The third water sub-tank 28 is arranged with a water recycling port 21. The lower annular structure is arranged with a second water outlet 27. The water recycling port 21 is connected with the second water outlet 27 or the water tank 2 via a water recycling pipe 22. FIG. 1-7, 10-48 can be used in this embodiment. FIGS. 2-48 can be composed of toy construction elements, the toy construction elements comprising couplings releasably interconnecting the toy construction elements.

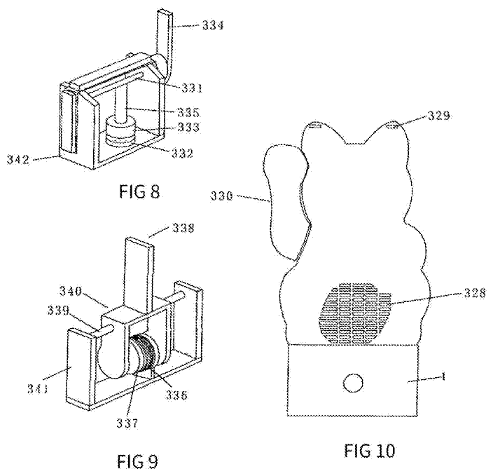

FIG. 10 illustrates another decoration that can be attached to the toy construction element decoration, and FIGS. 8-9 illustrate two moving mechanisms used with the decoration of FIG. 10. The moving mechanisms shown in FIGS. 8-9 include mainly a coil 332, 336; a magnet 333, 337; a shaft 339, 331; a rocking arm 334, 338; a rocking rode 335, 340; and a fastening frame 341, 342 when the coil 332, 336 is energized, a magnetic force is generated, the rocking rod 335, 340 moves back and forth, thus the rocking arm 334, 338 moves therewith. This makes an arm 330 in FIG. 10 moves back and forth. Numeral 329 in FIG. 10 designates a vapor exit from which a vapor can exit. Numeral 328 can be a speaker or a voice system or has an AI dialogue system, and can be linked with a smartphone or computer or other internet of things.

The mechanisms shown in FIGS. 8-10 can also be used with other embodiments shown in FIGS. 1-7, 27-48 of this invention.

FIGS. 11-26 have basically been shown in a U.S. Pat. No. 6,978,564 (hereinafter designated as '564) invented by the same inventor as that of the present invention.

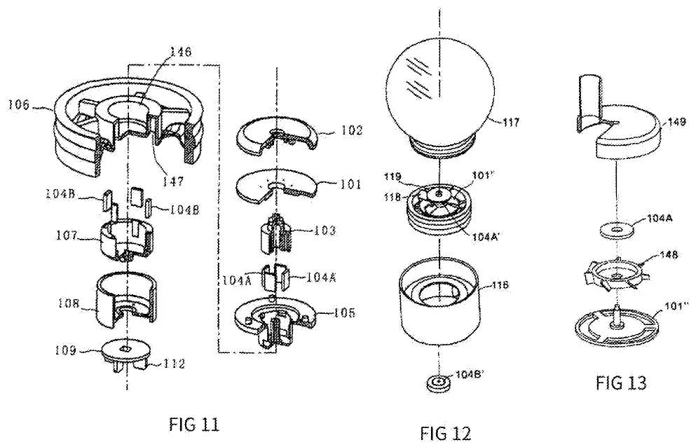

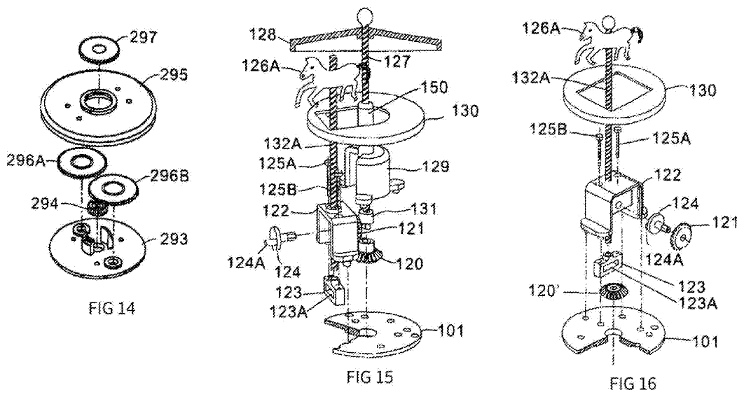

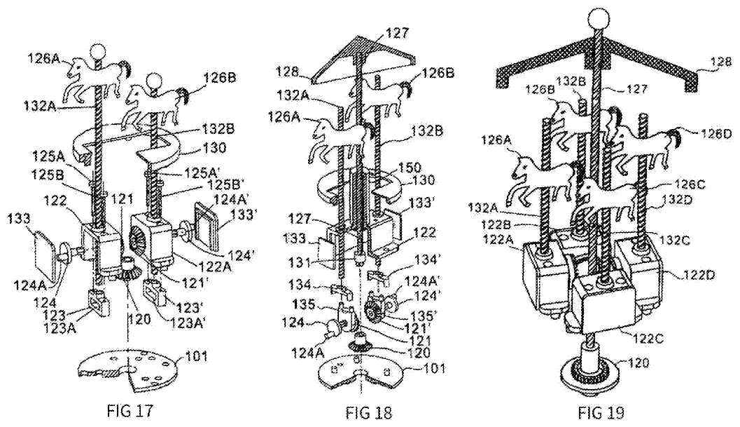

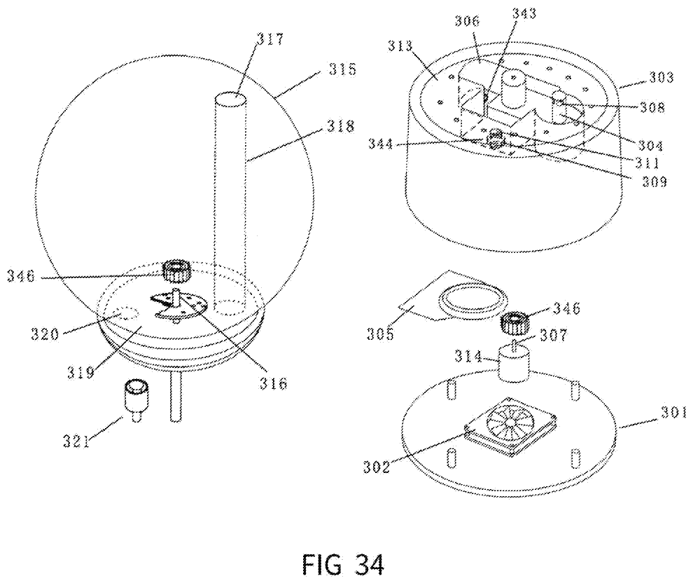

FIGS. 11, 12, . . . , 25, and 26 illustrate a first, second, . . . , fifteenth, and sixteenth subassembly, respectively, that can be engaged with the shaft 507 of FIGS. 4-7, 42-48 and shaft 307, 316 of FIGS. 34-40 and used with the embodiments shown in FIGS. 1-48.

FIG. 11 The first magnets 104A and the second magnets 1046 are for transmitting a movement from a power source from under a stopper member 106 to over the stopper member. A first rotary member 103, a second rotary member 107, a connecting member 105, and a lid 101 can further be provided. The first magnets 104A are installed in the first rotary member 103, the second magnets 104B are installed in the second rotary member 107, the connecting member 105 is fastened to the stopper member 106 and is provided for rotatably accommodating the first rotary member 103, the lid 101 is installed on the connecting member 105 for preventing the first rotary member 103 from falling off. The stopper member 106 can be provided with a first recessed portion 146 for accommodating the first rotary member 103 and the connecting member 105, and a second recessed portion 147 for accommodating the second rotary member 107.

The second rotary member 107 is fastened to the rotary piece 109 so as to rotate therewith. A socket member 108 which can be fastened to the stopper member 106 is for accommodating the second rotary member 107 so as to confine or stabilize the movement of the second rotary member 107. Numeral 102 designates a support on which a figurine or a subassembly can be positioned.

A rotary coupler 112 provided with the rotary piece 109 can be engaged with the shaft 507 of FIGS. 4-7, 42-48 and shaft 307, 316 of FIGS. 34-40 or other embodiments so that the subassembly shown in FIG. 11 can be in the water receptacle 2. The stopper member 106 can be rubber, metal, plastic or other suitable material.

FIG. 12 The subassembly has a decorative base member 116, a transparent housing 117, at least a first magnet 104A, and at least a second magnet 104B, at least one vane 118 fastened to the first magnet 104A for agitating some particles in the transparent housing 117 so that it looks like some flurries are moved upwardly and falling down. A lid 101 for installing the vane 118 and the magnet 104A; and another lid 119 provided to prevent the vane 118 and the magnet 104A falling off. This subassembly can be connected to the shaft 507 in FIGS. 4-7, 42-48 and shaft 307, 316 of FIGS. 34-40 and can work with other embodiments and be inside of the water receptacle 2.

FIG. 13 is the same as FIG. 5 of '564, in which the subassembly includes a rotary member 148 and a magnet 104A positioned in a lid 101; and a lid 149 covering the lid 101, the rotary member 148, and the magnet 104A and has an opening so that the particles agitated by the rotary member 148 can exit. This subassembly can be connected to the shaft 507 in FIGS. 4-7, 42-48 and shaft 307, 316 of FIGS. 34-40 and can work with other embodiments and be inside of the water receptacle 2.

Please note that the subassemblies shown in FIGS. 8-33 not only be inside of the water receptacle 2, but also be outside of the water receptacle 2.

FIG. 14 Two gears 296A and 296B are located engageable with the gear 294. The teeth of the gears 296A and 296B engage with teeth of a rotary cover 295. The teeth of the rotary plate 295 are provided on the inside face of a vertical wall on the peripheral of the rotary cover 295. When the shaft 307 or 316 rotates counterclockwise, the gear 294 does the same, and the gears 296A and 296B, and the rotary cover 295 rotate clockwisely, and vice versa. A gear 297 can be fastened to the gear 294 or the rotary cover 295 so as to drive other elements not shown in the drawings. We can also eliminate the gear 297 and have a figurine or decoration mounted on the rotary cover 295. The subassembly shown in FIG. 14 can work with other embodiments or subassemblies and can be inside or outside of the water receptacle 2.

FIG. 15 is the same as FIG. 8 of '564, in which a gear 120 on a lid 101 can be connected with the shaft 507 shown in the FIG. 7. A connecting piece 131 is fastened to the gear 120 and is fixed with a rotary shaft 127 which is installed with a canopy 128. A housing 129 is provided around the shaft 127 indirectly (with a tube 150 in between) to stabilize the rotation of the shaft. The purpose of tube 150 is to protect the shaft 127. A plate 130 is positioned around the shaft 127 for supporting some decoration (not shown in the drawings). Another gear 121 is engaged with the gear 120 and fastened with a wheel 124 which has an elongated drive stub 124A. A housing 122 is fixed to the lid 101 and is provided around the wheel 124. Another rotary shaft 132A and two guiding rods 125A and 125B are vertically inserted through the housing 122. A link 123 with a longitudinal slot 123A is fastened to the lower end of the rotary shaft 132A. A figurine (horse) 126A is fastened to the upper part of the rotary shaft 132A. The elongate drive stub 124A is movably located in the longitudinal slot 123A. The rotation of the gear 120 causes the rotation of the gear 121 and the wheel 124, which in turn causes the up and down movement of the link 123, the shaft 132A, the guiding rods 125A and 125B, and the horse 126A. The subassembly shown in FIG. 15 can work with other embodiments or subassemblies and can be inside or outside of the water receptacle 2.

FIG. 16 is the same as FIG. 9 of '564, in which a gear 120′ on a lid 101 can be connected with the shaft 507 shown in FIG. 7. Another gear 121 is engaged with the gear 120 and fastened with a wheel 124 which has an elongated drive stub 124A. A housing 122 is fixed to the lid 101 and is provided around the wheel 124. Another rotary shaft 132A and two guiding rods 125A and 125B are vertically inserted through the housing 122. A link 123 with a longitudinal slot 123A is fastened to the lower end of the rotary shaft 132A. A figurine (horse) 126A is fastened to the upper part of the rotary shaft 132A. The elongate drive stub 124A is movably located in the longitudinal slot 123A. The rotation of the gear 120 causes the rotation of the gear 121 and the wheel 124, which in turn causes the up and down movement of the link 123, the shaft 132A, the guiding rods 125A and 125B, and the horse 126A. The subassembly shown in FIG. 16 can work with other embodiments or subassemblies and can be inside or outside of the water receptacle 2.

FIG. 17 is the same as FIG. 10 of '564, in which a gear 120 over a lid 101 can be connected with the shaft 507 shown in FIG. 7. Two other gears 121 and 121′ are engaged with the gear 120 and fastened with wheels 124 and 124′, respectively, which have elongated drive stubs 124A and 124A′ respectively. Housings 122 and 122A are fixed to the lid 101 and are provided around the wheels 124 and 124′ respectively. Rotary shafts 132A and 132B and two pairs of guiding rods 125A, 125B, and 125A′, 125B′ are inserted through the housings 122 and 122A respectively. A plate 130 is provided around the shafts 132A and 132B for supporting some decoration (not shown in the drawings). Links 123 and 123′ with longitudinal slots 123A and 123A′ respectively are fastened to the lower end of the rotary shafts 132A and 132B respectively. The elongate drive stubs 124A and 124A′ are movably located in the longitudinal slots 123A and 123A′ respectively. The rotation of the gear 120 causes the rotation of the gears 121 and 121′ and the wheels 124 and 124′, which in turn causes the up and down movement of the links 123 and 123′, the shafts 132A and 132B, the guiding rods 125A, 125B, 125A′ and 125B′, and the horses 126A and 126B. Decoration plates 133 and 133′ are employed to cover a side of the housings 122 and 122A respectively. The subassembly shown in FIG. 17 can work with other embodiments or subassemblies and can be inside or outside of the water receptacle 2.

FIG. 18 is the same as FIG. 11 of '564, in which a gear 120 over a lid 101 can be connected with the shaft 507 shown in FIG. 7. FIG. 18 differs from FIG. 17 in that a connecting piece 131 is fixed to the gear 120 and is fastened with a rotary shaft 127 which is protected with a tube 150 and which is fastened with a canopy 128 on its top end. That is to say, all of the elements shown in FIG. 18, except the connecting piece 131, the rotary shaft 127, the tube 150, and the canopy 128, can also be exactly the same as the third embodiment shown in FIG. 17, instead of those shown in FIG. 18. In FIG. 18, one housing 122 is employed to replace the two housings 122 and 122A shown in FIG. 17. Links 134 are fastened to the lower ends of the shafts 132A and 132B respectively for being moved by the elongate drive stubs 124A and 124A, respectively. Two connecting pieces 135 are employed for installing the wheels 124, 124′ and the gears 121, respectively. The subassembly shown in FIG. 18 can work with other embodiments or subassemblies and can be inside or outside of the water receptacle 2.

FIG. 19 is the same as FIG. 12 of '564, in which a gear 120 can be connected with the shaft 507 shown in FIG. 7. The subassembly shown in FIG. 19 is very similar to the fourth embodiment (FIG. 18) of the subassembly. In FIG. 19, there are four rotary shafts 132A, 132B, 132C, 132D for installing four horses 126A, 126B, 126C, 126D respectively. Four housings 122A, 122B, 122C, 122D are provided around the four rotary shafts 132A, 132B, 132C, 132D respectively. A rotary shaft 127 is installed on a bearing 120 and is fastened with a canopy 128. The subassembly shown in FIG. 19 can work with other embodiments or subassemblies and can be inside or outside of the water receptacle 2.

FIGS. 20 and 21 are the same as FIGS. 13 and 14 of '564, in which a gear 120″ over a lid 101 can be connected with the shaft 507 shown in FIG. 7. A housing 122E can be fastened to the lid 101. A support tube 139 is provided on the housing 122E, for rotatably supporting a shaft 141. A wheel 136 and a gear 171 (which is engageable with the gear 120″) are fixed on the shaft 144. An elongate drive stub 137 is provided on the wheel 136. The stub 137 can be inserted through a hole provided on a rod 172 on which a figurine or a decoration can be fixed. A ring 138 and a fastening piece 140 are fixed to the stub 137 and the end of the shaft 141, respectively. When the gear 120″ rotates, the gear 171 and the wheel 136 rotate, thus in turn the stub 137 causes the rod 172 to do reciprocating movement. The subassembly shown in FIGS. 20 and 21 can work with other embodiments or subassemblies and can be inside or outside of the water receptacle 2.

FIG. 22 is the same as FIG. 15 of '564, in which a gear 120″ over a lid 101 can be connected with the shaft 507 shown in FIG. 7. A housing 122F can be fastened to the lid 101. Two support tubes 144 and 145 can be formed on the housing 122F, for rotatably supporting shafts 141 and 143. A wheel 136 and a gear 171 (which is engageable with the gear 120″) are fixed on one side of the shaft housing 122F 141. Another wheel 136′ is fixed in the other side of the shaft 141. The wheels 136 are 136′ are provided with elongate drive stubs 137 and 137′, respectively. Connecting pieces 142 and 142′ are fixed to the two ends of the shaft 141, respectively. Longitudinal slots 176′ and 176″, in which the elongate drive stubs 137 and 137′ can slide respectively, are formed on the connecting pieces 142 and 142′, respectively. Figurines or decorations can be positioned on the connecting pieces 142 and 142′. A plate 130 is provided for supporting figurines or decorations. When the gear 120″ rotates, the gear 171, the shaft 141, and the wheels 136 and 136′ rotate therewith, thus in turn causing the connecting pieces 142 and 142′ to do reciprocating movement. The subassembly shown in FIG. 22 can work with other embodiments or subassemblies and can be inside or outside of the water receptacle 2.

FIG. 23 is the same as FIG. 16 of '564, in which a gear 128″ over a lid 101 can be connected with the shaft 507 shown in FIG. 7. A rod 175 is fixed on the lid 101. A gear 171′ and a wheel 136″ having a through hole in the central portion thereof respectively are rotatably installed on the rod 175. The gear 171′ is engageable with the gear 120″. An elongated drive stub 137″ is formed on the wheel 136″. A connecting piece 142″, on which a figurine or decoration can be fixed, is rotatably installed on top of the gear 120″. The connecting piece 142″ is formed with a longitudinal slot 176 in which the elongate drive stub 137″ can slide. A lid 177 is positioned over connecting piece 142″ for confining the movement of the connecting piece 142″. When the gear 120″ rotates, the gear 171′, and the wheel 136″ rotate, thus in turn causes a reciprocate movement of the connecting piece 142″. The subassembly shown in FIG. 23 can work with other embodiments or subassemblies and can be inside or outside of the water receptacle 2.

FIG. 24 is the same as FIG. 17 of '564, in which a wheel 178 having an elongated drive stub 179 can be connected with the shaft 507 shown in FIG. 7. A plurality of tubes 193, 191, 180 having a longitudinal slot 195 is fixed with a tube 216 having a hole 185 and a gear plate 181. A tube 183 having a hole 184 is fixed with a gear plate 182. The elongate drive stub 179 is located in the longitudinal slot 195 and slidable therein when the wheel 178 rotates. A cover plate 186 is positioned on the lid 101″′ and is provided with holes 194, 190 and 190′. The upper ends of the tubes 193 are fastened at the holes 194 of the cover plate 186. Two supports 188 and 188′ for supporting figurines or decorations thereon are fixed with rods 215 and 215′ respectively. The rods 215 and 215′ are inserted through the holes 190 and 190′ respectively, and fastened in the holes 185 and 184 of the tubes 216 and 183 respectively. The tubes 216 and 183 are rotatably installed in the tubes 191 and 191′ respectively. When the wheel 178 rotates, the elongate drive stub 179 drives the moving piece 180, the tube 216 and the gear plate 181 which engages with the gear plate 182 to reciprocate. Thus this causes the gear plate 182, the tube 183, the rods 215 and 215′, and the supports 188 and 188′ to reciprocate. The subassembly shown in FIG. 24 can work with other embodiments or subassemblies and can be inside or outside of the water receptacle 2.

FIG. 25 is the same as FIG. 18 of '564, in which a wheel 178′ having an elongated drive stub 179′ can be connected with the shaft 507 shown in FIG. 7. A plurality of tubes 193′, 196A, 196B, 196C, and 196D are provided on the lid. Rotary tubes 197A, 197B, 197C, and 197D are rotatably installed in the tubes 196A, 196B, 196C, and 196D respectively, and fastened with connecting pieces 199A, 199B, 199C, and 199D respectively, which are provided with longitudinal slots 200A, 200B, 200C, and 200D respectively. The elongate drive stub 179′ can be inserted into the longitudinal slots 200A, 200B, 200C, and 200D and slide therein when the wheel 178′ rotates. A cover plate 186′ is positioned on the lid 202 and is provided with holes 218, 218′, 201A, 201B, 201C, and 201D. Supports 198A, 198B, 198C, and 198D for supporting figurines or decorations thereon are fastened with rods 217A, 217B, 217C, and 217D respectively, which insert through the holes 201A, 201B, 201C, and 201D on the cover plate 186′ respectively, and installed in the rotary tubes 197A, 197B, 197C, and 197D respectively. When the wheel 178′ rotates, the elongate drive stub 179′ drives the connecting pieces 199A, 199B, 199C, and 199D to reciprocate, and the rotary tubes 197A, 197B, 197C, and 197D to rotate, respectively. Thus the rods 217A, 217B, 217C, and 217D, and supports 198A, 198B, 198C, and 198D rotate respectively. The cover plate 186′ is fastened to the upper ends of the tubes 193′ at the holes 218 and 218′. The movement of the connecting pieces 199A, 199B, 199C, and 199D does not interfere with each other because they are on different heights (levels). The subassembly shown in FIG. 25 can work with other embodiments or subassemblies and can be inside or outside of the water receptacle 2.

FIG. 26 is the same as FIG. 19 of '564, in which a gear 204 can be connected with the shaft 507 shown in FIG. 7. A rod 219 and tubes 203 and 203′ are provided on the lid 202′. A gear 221 and a wheel 210 having an elongated drive stub 214 are rotatably provided on the rod 219. A gear 204 engageable with the gear 221 can be installed on a rotary rod 219 and tubes 103 (FIG. 1) and rotate therewith. A rotary tube 212 is fixed with a gear plate 213 which is engageable with a gear plate 213′ fixed with a rotary tube 212′. A moving piece and a longitudinal slot (in which the elongate drive stub 214 slides) similar to the moving piece 180 and the longitudinal slot 195 shown in FIG. 17 are provided under the gear plate 213 and fixed to the rotary tube 212. Supports 211 and 211′ for supporting figurines or decorations having rods 222 and 222′ are fastened to the rotary tubes 212 and 212′ respectively, with the rods 222 and 222′ inserted into the tubes 212 and 212′ respectively. When the wheel 210 rotates, the stub 214 drives the tubes 212 and 212′, the gear plates 213, and 213′, and the supports 211, and 211′ to move. A housing 209 is fastened to the lid 202′, with a rotary shaft 132 provided therethrough. A gear 205 (engageable with the gear 204) and a wheel with an elongate drive stub (not shown in the drawing) (similar to the gear 121 and wheel 124 with an elongate drive stub 124A in FIG. 8) can be installed on the housing 209. A link with a longitudinal slot (not shown in the drawing) (similar to the link 123 with the longitudinal slot 123A in FIG. 8) can be fixed to the lower end of the shaft 125. When the wheel 205 rotates, the shaft 132 and the horse 126 move upwardly and downwardly. Another housing 220 is fastened to the lid 202′ with a gear 206 rotatably installed on it. The gear 206 is engageable with the gear 204. The inside structure of the housing 220 is similar to that shown in FIGS. 13 and 14 (i.e., a wheel with an elongate drive stub not shown in the drawing is fastened to the gear 206). A connecting piece 207 having a longitudinal slot 223 is rotatably installed on a shaft 208. The elongate drive stub in the housing 220 is located in the longitudinal slot 223 and can slide thereon. A figurine or a decoration can be fastened to the connecting piece 207. When the gear 206 rotates, the wheel rotates, the stub drives the connecting piece 207 to reciprocate. The subassembly shown in FIG. 26 can work with other embodiments or subassemblies and can be inside or outside of the water receptacle 2.

The inventor of the present invention also has the following twelve U.S. patents granted: U.S. Pat. Nos. 5,078,386; 5,088,373; 5,070,753; 5,286,535; 4,890,828; 5,203,743; 4,987,787; 6,978,564, 4,939,944; 5,448,007; 5,081,899; and 5,163,878. These patents can be used with the structures of FIGS. 1-7, 31-48 of the present invention.

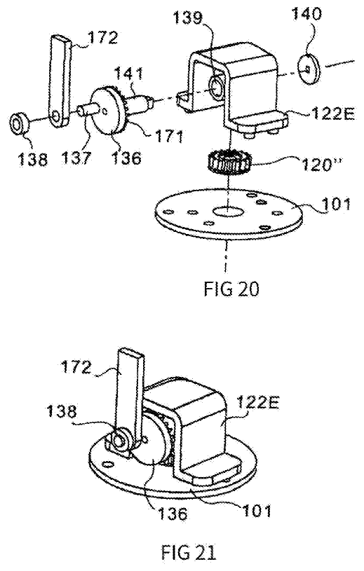

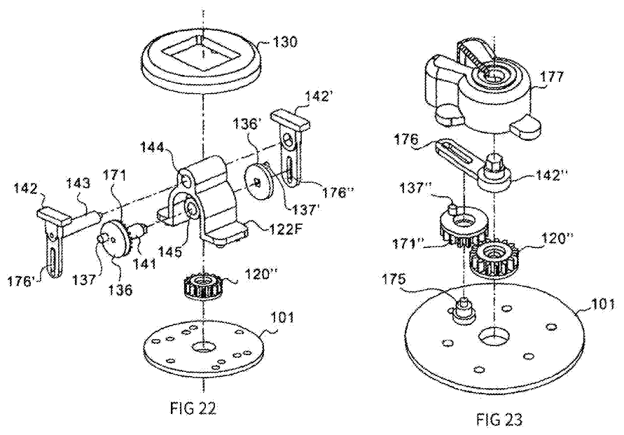

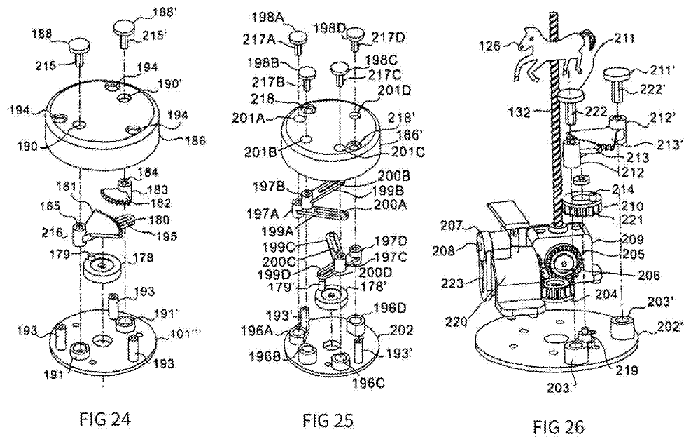

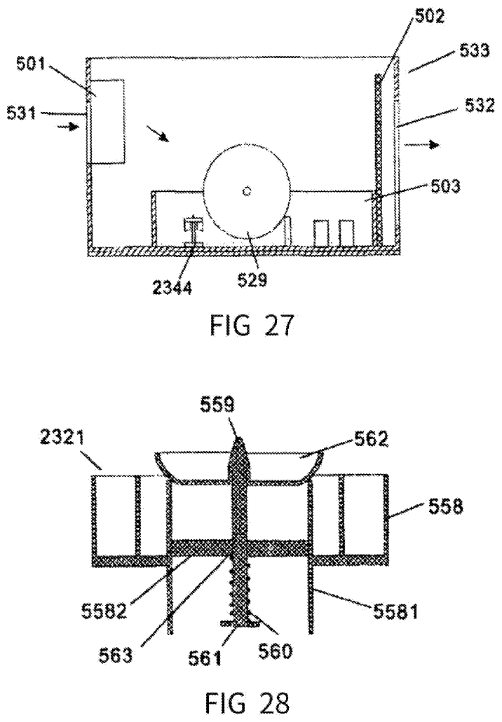

FIG. 27 shows seat 533 of the embodiments in the present invention. A water wheel 529 is provided in the water sub-receptacle 503. When the fan 501 is turned on, wind blows from the wind inlet 531, toward the water and water wheel 529 in the water sub-receptacle 503 so that the water wheel 529 rotates and the water in the water sub-receptacle 503 moves, so as to clean the air. The number of the water wheel 529 can be one or more than one. The structures shown in FIGS. 1-7 and 28-48 also can be used with this structure.

FIG. 28 shows a sectional view of the water exit valve 12 in FIGS. 2-7, A hollow rod-shaped structure 5581 is provided in an outer housing 558 which has a larger diameter than that of the hollow rod-shaped structure 5581. The hollow rod-shaped structure 5581 is provided with a horizontal rod 5582 which in turn is provided with a communication hole 563 in which an abutment rod 581 is provided. A conical shaped retaining head 559 is provided on the top of the abutment rod 561 which is surrounded with a spring 560 on the lower portion thereof. One end of the spring 560 abuts against the hollow rod-shaped structure 5581, the other end of the spring 560 abuts against the bottom of the abutment rod 561. A soft stopper (which can be made of rubber, plastic, or other suitable material) 562 is provided under and around the conical shaped retaining head 559. The soft stopper 562 is of a shape similar to a bowl, with a lower edge abuts against the hollow rod-shaped structure 5581. When in use, the outer housing 558 is fit to the water receptacle at the water exit 4.

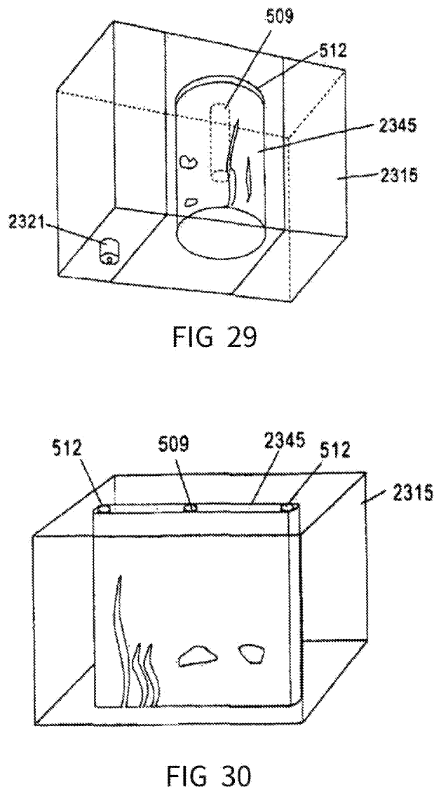

FIGS. 29-30 show two extended mechanisms of the present invention. These two mechanisms also can be used with the structures shown in FIGS. 1-7, 27 and 31-48.

As shown in FIG. 29, a light 509 is provided in the water receptacle 2315. A decoration 2345 is provided outside of the light 509. A transmission mechanism 512 (which can be connected to the shaft 507 of FIGS. 4-7, 42-46 and shaft 307, 316 of FIGS. 34-40) is provided on the decoration 2345 so as to move the latter.

As shown in FIG. 30, two transmission mechanisms 512 (which can be of the shape of two rollers and one of them can be connected to the shaft 507 of FIG. 4-7, 44-48 and shaft 307, 316 of FIGS. 34-40) is provided in the decoration 2345. A light 509 is provided in the middle of the decoration 2345. When in use, as shown in FIGS. 29-30, the light 509 illuminates the pictures on the decoration 2345 so as to produce a visual effect which is an extra effect of the decorative humidifier of the present invention which can purify the air, humidify the air, and deliver the wind.

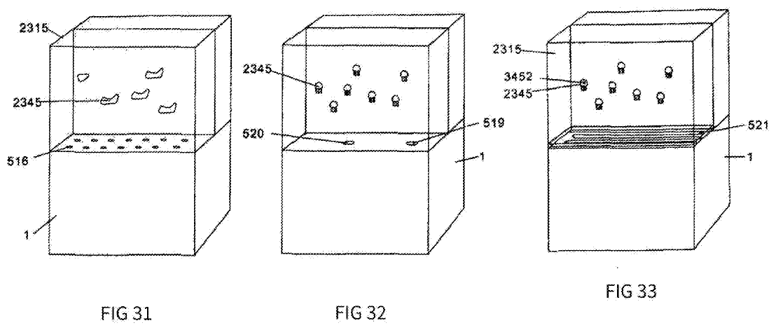

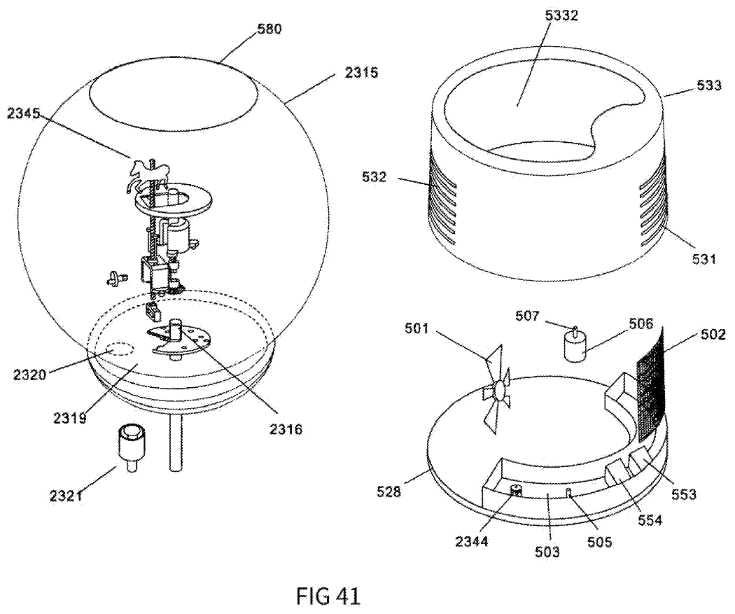

As shown in FIG. 31, a water receptacle 2315 is provided on the base land is provided with a plurality of second holes 516 (at its bottom) which in turn is connected with a pump 18 shown in FIGS. 4-7. pump 540 shown in FIGS. 43-46, A plurality of decorations 2345 are provided and are suspended (floated) in the water receptacle 2315. The pump 18 (in FIGS. 4-7) pump 540 shown in FIGS. 41-48 can pump air or can be a making water bubbles device to pumps water bubbles, through the second holes 516 in the bottom of the water receptacle 2315, the water bubbles in the water receptacle 2315 pushes the decorations 2345 (e.g. a plurality of fishes) upwardly, which in turn sink downwardly (because of their own weights) toward the bottom of the water receptacle 2315. Thus the decorations 2345 can repeatedly move upward and downwardly enhance the visual effects, which is an extra effect of the decorative humidifier of the present invention which can purify the air, humidify the air, and deliver the wind. FIGS. 29-30 can also serve as a background picture in this mechanism. The structures in FIGS. 1-48 can be used with this mechanism.

As shown in FIG. 32, a water receptacle 2315 is provided on the base 1 and is provided with a third water exit 520 and a first water inlet 519 at its bottom a vane (fan) 118 shown in FIG. 12 (or fan 148 in FIG. 13) or water pump 18, 540 connects with the first water inlet 519. A plurality of decorations (in the shapes of jelly fishes) are provided and are suspended (floated) in the water receptacle 2315. When the van 118 or fan 148 move, or the water pump 540 pumps water into the water receptacle 2315 through the first water inlet 519, the water enters the support seat 533 through the third water exit 520. Thus the water can circulate between the water receptacle 2315 and the support seat 533, so that the decorations 2345 can move upward and downward repeatedly. A light not shown in the drawings can also be provided to enhance the visual effects, which is an extra effect of the decorative humidifier of the present invention which can purify the air, humidify the air, and deliver wind. FIGS. 29-30 can also serve as a background picture in this mechanism. The structure in FIGS. 1-48 can also be used with this mechanism.

As shown in FIG. 33, a first magnetic device 521 is provided on the bottom of the water receptacle 2315 which in turn is provided on the base 1. A plurality of decorations 2345 are provided and are suspended (floated) in the water receptacle 2315. The decorations are provided with a second magnetic device 3452 respectively. When the first magnet device 521 is energized, the magnetic force thereof exerts a pushing force against the second magnetic devices 3452 (because of same polarity therewith) in the decorations 2345, so that the decorations 2345 are prevented from sinking to the bottom of the water receptacle 2315, and can move around in the water receptacle 2315. Each of the decorations are of different weights and therefore will move around at different heights in the water receptacle 2315. FIGS. 29-30 can serve also as a background picture in this mechanism. The structures FIGS. 1-48 can also be used with this mechanism.

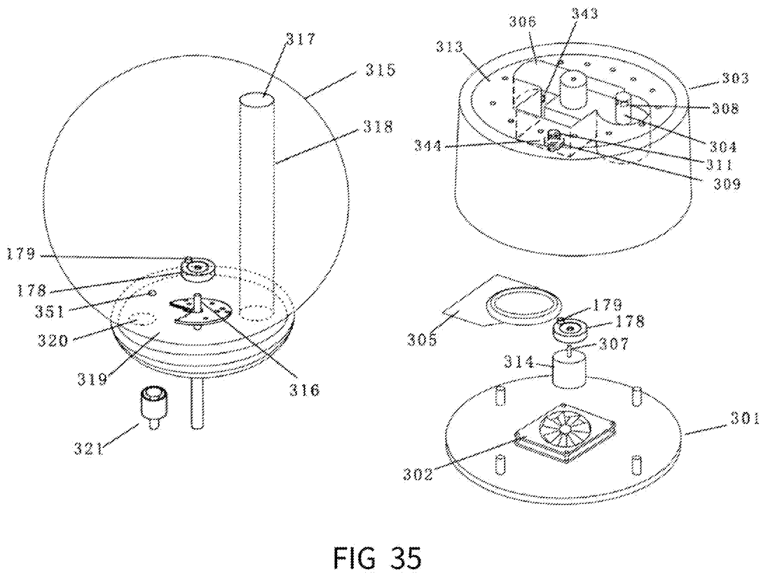

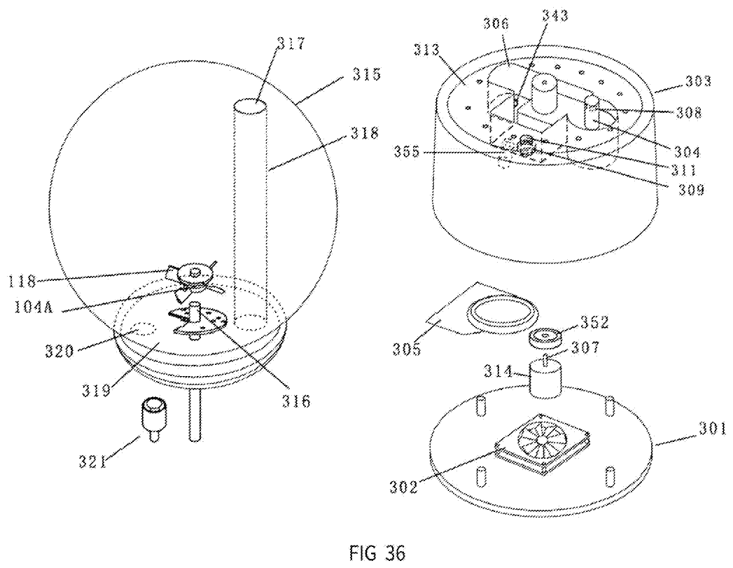

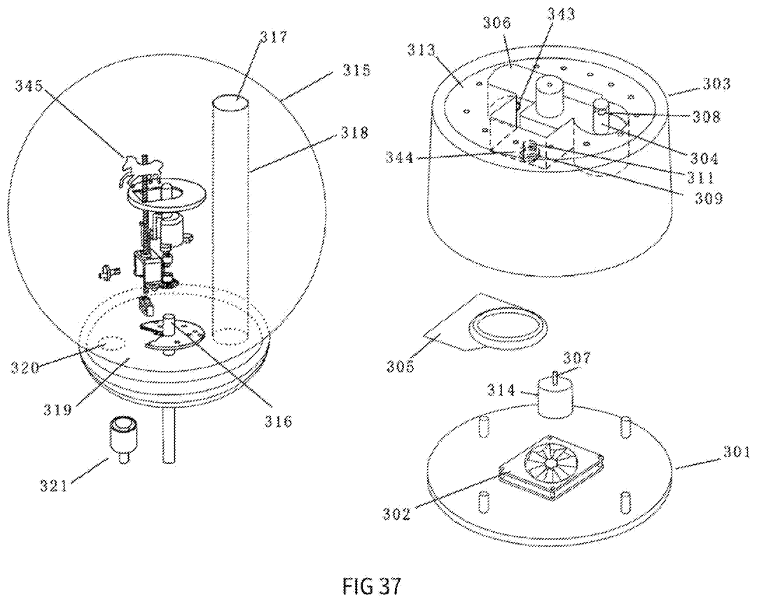

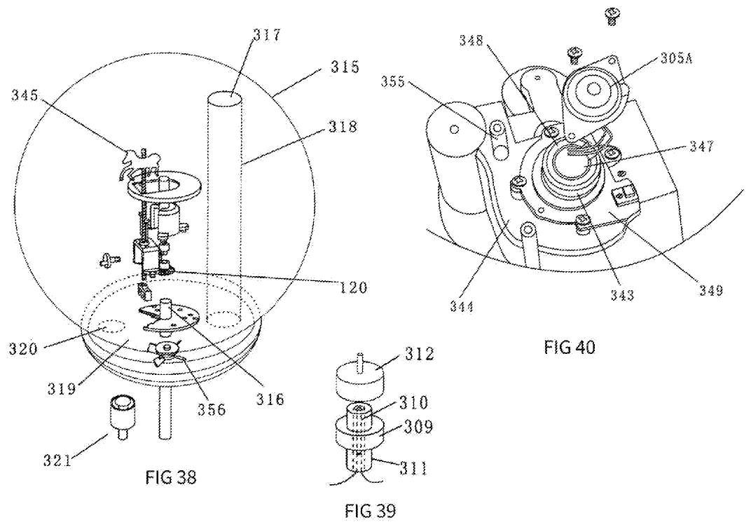

FIG. 34, a power source 314 having a shaft 307 which is operatively connected to a gear 346 are provided with the humidifier on a base plate 301 and a base board 319; in FIG. 35, a power source 314 having a shaft 307 which is operatively connected to a wheel 178 with an elongate drive stub 179 are provided with the humidifier on a base plate 301 and a base board 319, a light 351 is provided on the base board 319; in FIG. 36, a power source 314 having a shaft 307 which is operatively connected to a magnet 352 are provided with the humidifier on a base plate 301, a vane (fan) 118 and a magnet 104A are provided on the base board 319; in FIG. 37 simply the power source 314 having a shaft 307 are provided with the humidifier on a base plate 301, and a subassembly 345 and another shaft 316 are shown in a water receptacle 315; in FIG. 38, a fan 356, another shaft 316 and a subassembly 345 are provided in a water receptacle 315.

Please see FIGS. 34-37 for the detailed structure of the humidifier of the present invention. The humidifier mainly includes a base plate 301, a base seat 303, base plate 301 or base seat 303 can be comprising toy construction elements, the toy construction elements comprising couplings releasably interconnecting the toy construction elements, a water receptacle 315, a fan 302 installed on the base plate 301, a power source 314 (which can be a motor, a music box or the like), a shaft 307 of the power source 314, a sub-receptacle of water 306 in the base seat 303, a ultrasonic device 305 for transforming water into vapor, and a base board 319 of the water receptacle 315. The water receptacle 315 and the baseboard 319 are attached and sealed together so that the water in the water receptacle 315 does not leak through the border between the water receptacle 315 and the baseboard 319.

A water opening 320, a water exit valve 321, a vapor guide tube 318, and a vapor exit 317 are provided on the base board 319 for water receptacle 315. A spring not shown in the water exit valve 321 is provided for controlling the flow rate and on/off of the water flow downward from the water receptacle 315 through the baseboard 319, to the sub-receptacle for water 306. A shaft 316 operatively connected to the shaft 307 can be fastened with a gear 346. An opening not shown in the drawing can be provided on the upper side of the water receptacle 315 to refill water, the water receptacle 315 is fixed on top of the base seat 3.

An air guide to be 304 with an air opening 308 is provided on the sub-receptacle for water 306. Numeral 311 designates a water separation tube which is shown in FIG. 39; numeral 344 designates a base face of the sub-receptacle 306 for water; numeral 343 designates an opening where an ultrasonic device 305 (for transforming water into vapor) is installed next to it. The detailed structure of the ultrasonic device 305 is shown in FIG. 40. The ultrasonic device 305 can be replaced with a heater, a fan, or other conventional device for transforming water into vapor. Numeral 313 designates an upper face of the base seat 305. When the atomization device is to be used, the water receptacle 315 is filled with water, the water can flow through the water opening 320 and into the sub-receptacle of water 306. The humidifier is turned on, the ultrasonic device 305 generates vapor. The fan 302 on the base plate 301 sucks air from the space under the fan 302 upward, forcing the air to go through the air guide tube 304, toward the air opening 308. A recessed space is formed around the vapor guide tube 318 and the air guide tube 304 at the base board 319 for collecting vapor there. The air which is forced through the air opening 308 pushes the vapor through the vapor guide tube 318 and forces the vapor to exit through the vapor exit 317.

From the right upper half of FIG. 34, we can see that the air guide tube 304 is higher than the sub-receptacle of water 306 and the upper face 313 of the base seat 303, and the upper face 313 contacts tightly with the base board 319 of the water receptacle 315, therefore the water would not flow downward through the air opening 308.

When the power source 314 is turned on, the shaft 307 and the shaft 316 on top of the what 307 rotates to move the subassembly or the decoration (shown in e.g. FIGS. 8-26) operatively connected therewith.

Numeral 355 in FIGS. 36 and 38 designates an ozone mechanism for delivering ozone into the water in the sub-receptacle of water 306 under the water receptacle 315, so that the water therein contains ozone and the vapor from the humidifier also contains ozone. Alternatively, the ozone mechanism 355 can also be provided on the base seat 303. The fan 302 on the base plate 301 sucks air from the space under the fan upwardly, forces the air and the zone to go through the air guide tube 304, toward the air opening 308, so that the air, ozone, and vapor go through the vapor guide tube 318 and exit through the vapor exit 317.

In FIGS. 37 and 38, a subassembly 345 can be installed in the water receptacle 315. Alternatively, the subassemblies or structures shown in FIGS. 34 and 8-26 can also be installed therein.

In FIG. 38, a fan 356 and the subassembly 345 are installed in the water receptacle 315 so that the fan 356 and the subassembly 345 (or other subassemblies or structures shown in FIGS. 8-26) can be rotated simultaneously.

FIG. 39 depicts an automatic safety device for the humidifier, which is installed at the base face 344 of the sub-receptacle of water 306 on the base seat 303. The automatic safety device includes mainly a water separation tube 311, a sensing piece 310 in the water separation tube 311, a magnetic float 309 around the water separation tube 311, and a fixed head 312. When the sub-receptacle of water 306 is filled with water, the magnetic float 309 floats, thus the magnetism of the magnetic float 309 is sensed by the sensing piece 310 and the power is energized. On the other hand, when there is not enough water in the sub-receptacle of water 306, the magnetic float 309 drops downward, and the power is de-energized. This mechanism can be used in other drawings or embodiments of the humidifier of this invention.

FIG. 40 depicts a detailed structure of the ultrasonic device 305 A for transforming water into vapor, in which numeral 347 designates an ultrasonic sheet which is surrounded with a rubber sheet 348. A printed circuit board 347 is provided for the ultrasonic device 305. An opening 343 is provided on the sub-receptacle of waster 306 of the base seat 303. Numeral 344 designates a base face of the sub-receptacle of water 306. An upper lid 305A holds the ultrasonic sheet 347 and the rubber sheet 348 in place, so that the water would not leak. When the humidifier is activated, the ultrasonic sheet 347 is activated to transform the water in the sub-receptacle of water 306 into vapor. A water absorption strip or Absorbent tube (not shown in this FIG), can be made by any kind of material to easily suck water, working with ultrasonic device 305 for transforming water into vapor.

FIGS. 41-43 show the structures of the embodiments A-C of the toy decorative humidifier of the present invention.

These embodiments show some structures that are different from those shown in FIGS. 34-38, while these embodiments are also for humidifying and cleaning the air, and can use similar shaft (e.g. shaft 307 or 316 of FIGS. 34-38, or shaft 507 or 2316 of FIG. 41), and can be used with the structures shown in FIGS. 8-33 so as to enhance the decorative and functional effects.

The embodiment A is shown in FIG. 41 and includes mainly a support seat 533 and a water receptacle 2315. The support seat 533 has a first opening 5332 in which a fan 501 is accommodated. The support seat 533 is also provided with a bottom lid 528, a water sub-receptacle 503, and a filter 502. An automatic safety device 2344 (which can be the same as or similar to that shown in FIG. 39) and a water level control rod 505 are provided in the water sub-receptacle 503. A base seat 2319 can be fixed in the water receptacle 2315. A first water exit 2320 is provided on the water receptacle 2315. A water exit valve 2321 is provided on the first water exit 2320. A shaft 2316 is provided in the water receptacle 2315. An end of the shaft 2316 can be connected to a motor 506 (the shaft 2316 can be connected to a motor of the fan 501 instead of motor 506). Likewise, an end of the shaft 507 can be connected to the motor 506, or to a motor of the fan 501. The other end of the shaft 2316 or 507 can be connected with a decoration 2345, or be connected with the mechanisms shown in FIGS. 8-26 first, and then connected with a decoration 2345. An opening can be provided on the water receptacle 2315 which is covered with a lid 580 which can be opened so that water can also be filled into the water receptacle 2315. A wind exit (opening) 532 and a wind inlet (opening) 531 are provided on the support seat 533. The water receptacle 2315 is fixed on the support seat 533. The lid 580 and the support seat 530 can also be formed integrally. When the water receptacle 2315 is filled with water, the water falls through the first water exit 2320 and water exit valve 2321, then falls through the water level control rod 505 and enters the water sub-receptacle 503. The water level in the water sub-receptacle 503 is controlled by the water exit valve 2321 and the water level control rod 505. When the power of the present invention is turned on, the fan 501 is activated to draw air which enters through a wind inlet 531, passes through a filter 502 (so that the air can be cleaned), and exits through a wind exit 532. The lower end of the filter 502 also can be submerged in the water in the water sub-receptacle 503, and the filter 502 can also be made of water-absorbent material, so that the water can go up and make the filter 502 wet and so that when wind passes through the filter 502, the water will evaporate and the air can be humidified. Various decorations 2345 can be used with the present invention. A bag 553 which can contain ice cubes, air freshener, aromatic material, or the like, and an air cleaner 554 also can be put in the water sub-receptacle 503 to enhance the function of the present invention.

The motor 506 can be used to drive the shaft 2316 (FIGS. 41-43) so as to drive the decorations 345 in the water receptacles shown in FIGS. 37-38, the decorations 2345 in the water receptacles shown in FIGS. 29-30, or the decorations and the mechanisms in the water receptacles shown in FIGS. 8-26 (e.g. magnets 104B in FIGS. 11-12, vane 118 in FIG. 12, fan 356 in FIG. 38, gears 294, 120, and 120′ in FIGS. 14-16 respectively, and eccentric wheels 124, 141, 178, and 178′ in FIGS. 15,24-26 respectively).

FIG. 41 just exemplifies a mechanism in the water receptacle 2315. The motor 506 can also drive the fan 501 if necessary. The motor for driving the fan 501 can also be used for driving the shaft 2316.

The motor 506 can be used to drive the shaft 507 so as to drive the decorations outside of the water receptacle through the mechanisms shown in FIGS. 8-26 (e.g. decorations 2345 in FIGS. 29-30, decorations 126A, 126B in FIGS. 8-26, decorations in FIG. 10 arm 330). The shaft 507 also can be connected to the magnets 104B in FIGS. 11-12, or the fan 356 in FIG. 38, gears 294, 120, and 120′ in FIGS. 114-16 respectively, and eccentric wheels 124, 141, 178, and 178′ in FIGS. 16-26 respectively, or a belt conveyor and be connected to the decorations through the mechanisms outside of the water receptacle.

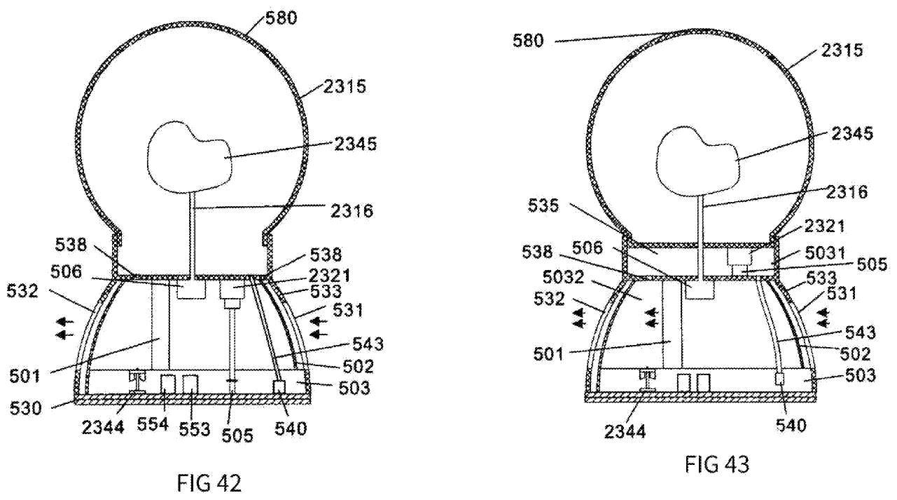

FIG. 42 shows the embodiment B of the present invention. Embodiment B is similar to embodiment A shown in FIG. 41. In FIG. 42, a water pump 540 is connected with a water pipe 543, at least one second water exit 538 is provided on top of the support seat 533. The water pump 540 pumps water into the water receptacle 2315 through the water pipe 543. When the fan 501 is turned on, the wind blows toward a water curtain (water falls) formed with the water in the water receptacle 2315 which flows downward from the second water exit 538. The air in the wind can be cleaned because it goes through the water curtain (falls). The water can then flow into the water sub-receptacle 503, and then into the water receptacle 2315 through the water pump 540 and the water pipe 543. This movement occurs repeatedly and the air can be cleaned with minimum energy. The mechanisms shown in FIGS. 8-33 also can be used with this structure.

FIG. 43 shows the embodiment C of the present invention. An upper chamber 5031 and a lower chamber 5032 are provided on the support seat 533. The water sub-receptacle 503 and the fan 501 are provided on the lower chamber 5032. A water reservoir 535 is provided in the upper chamber 5031. A second water exit 538 is provided on one side of the water reservoir 535. When the water receptacle 2315 is filled with water, the water in the water receptacle 2315 enters the water reservoir 535 through the water exit valve 2321 and the water level control rod 505. The water level in the water reservoir 535 is controlled with the water exit valve 2321 and the water level control rod 505. As an alternative, an independent water reservoir (not shown in the drawings) can be provided around the water level control rod 505. The independent water reservoir is separate from the second water exit 538, so that the water in the water receptacle 2315 does not discharge through the second water exit 538 completely. An opening 531 and an opening 532 are provided on the support seat 533 (the opening 531 can be wind inlet, the opening 532 can be wind exit, and vice versa). A filter 502 can be provided inside of the opening 531, a bag 553 which can contain ice cubes, air freshener, aromatic material, or the like, and an air cleaner 554 can also be put in the water sub-receptacle 503. A second water exit 538 is provided in the water reservoir 535. Water can flow from the water reservoir 535, through the water second exit 538, the filter 502, and into the water sub-receptacle 503. Water can also flow from the water second exit 538 on the other end and into the water sub-receptacle 503 directly. When the fan 501 is turned on, wind blows toward the filter 502 from the opening 531 and exits through the opening 532 so that it can be cleaned. Wind can also blow toward the filter 502 from the opening 532 and exit through the opening 531 so that it can be cooled down and/or added with freshener, or aromatic material while being cleaned. In the meanwhile, the water pump 540 is connected with the water reservoir 535 through a water pipe 543. When the fan 501 is turned on, the wind blows toward a water curtain (waterfalls) formed with the water in the water receptacle 2315 which flows downward from the second water exit 538.

The inventor of the present invention also has the following twelve U.S. patents granted: U.S. Pat. Nos. 5,078,386; 5,088,373; 5,070,753; 5,286,535; 4,890,828; 5,203,743; 4,987,787; 6,978,564, 4,939,944; 5,448,007; 5,081,899; and 5,163,878. These patents can be used with the structures of FIGS. 1-7, 34-38, 41-48 of the present invention.

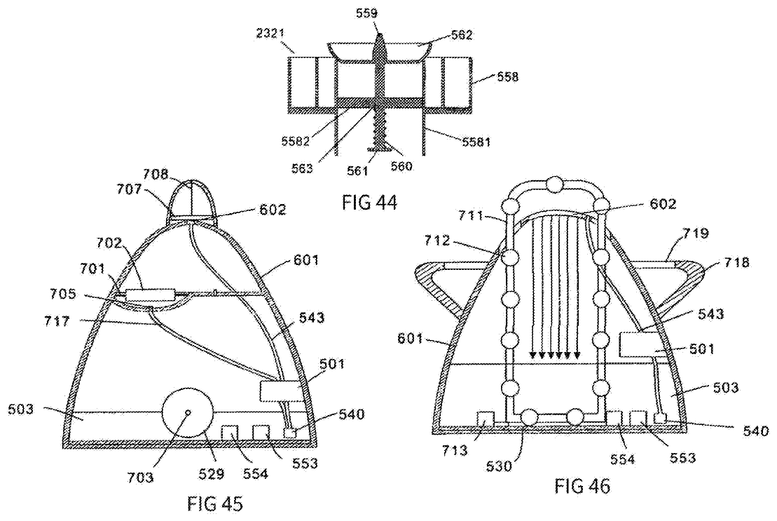

FIG. 44 shows a sectional view of the water exit valve 321 in FIGS. 34-38, and the water exit valve 2321 shown in FIGS. 41-43. A hollow rod-shaped structure 5581 is provided in an outer housing 558 which has a larger diameter than that of the hollow rod-shaped structure 5581. The hollow rod-shaped structure 5581 is provided with a horizontal rod 5582 which in turn is provided with a communication hole 563 in which an abutment rod 581 is provided. A conical shaped retaining head 559 is provided on the top of the abutment rod 561 which is surrounded with a spring 560 on the lower portion thereof. One end of the spring 560 abuts against the hollow rod-shaped structure 5581, the other end of the spring 560 abuts against the bottom of the abutment rod 561. A soft stopper (which can be made of rubber, plastic, or other suitable material) 562 is provided under and around the conical shaped retaining head 559. The soft stopper 562 is of a shape similar to a bowl, with a lower edge abuts against the hollow rod-shaped structure 5581. When in use, the outer housing 558 is fit to the water receptacle (315 in FIGS. 34-38, 2315 in FIG. 41) at the water exit 2320. After the water receptacle 2315 is fit to the support seat 533, the abutment rod 561 of the water exit valve 2321 abuts the water level control rod 505 (FIGS. 41-44), the abutment rod 561 and the spring 560 are pushed upwardly, thus the soft stopper 562 is pushed released and water enters the water sub-receptacle 503. When the water receptacle 2315 is separated from the water sub-receptacle 503, the abutment rod 561 does not push against the spring 560 and the water stops exiting. When the water level in the water sub-receptacle is parallel with the horizontal rod 5582, the water in the water receptacle stops entering the water sub-receptacle.

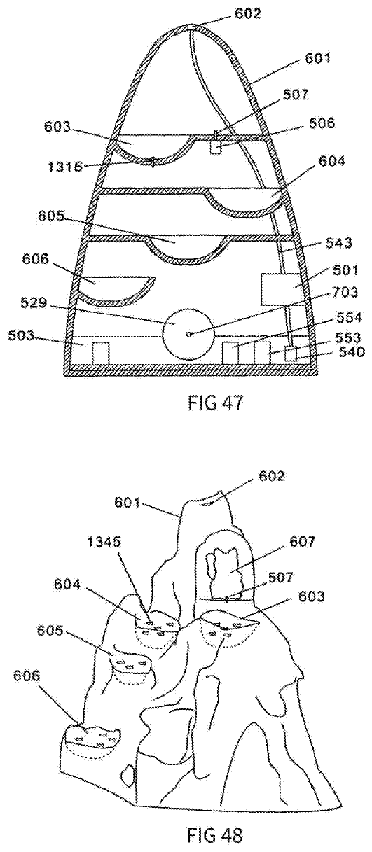

FIGS. 45-48 show various embodiments of the present invention which are similar but different from the structures shown in FIGS. 34-38. The embodiments shown in FIGS. 45-48 can use same shaft (307 and 316 in FIGS. 34-38, 708 and 703 in FIG. 45, and 507 and 1316 in FIG. 47), and can blow wind, humidify the air, and clean the air, while providing a special effects of a waterfall. These embodiments can be used with the structures shown in FIGS. 8-26 and 27-40, to enhance the functional and decorational effects.

As shown in FIG. 45, the embodiment can have the visual effects of a waterfall, and has a decorative housing 601, which has a first water exit 602. A water sub-receptacle 503 is provided on the lower part of the housing 601. A filter 530, a bag 553 having ice, air freshener, and/or aromatic material, and an air cleaning device 554 can be provided on the bottom of the water sub-receptacle 503, which also has a water pump 540 which is connected with a first water exit 602 through a water pipe 543. Water repeatedly flows from the water exit 602 and creates visual effects of a waterfall, which can clean the air blown against the waterfall by a fan 501. Therefore, this embodiment can clean the air, humidify the air, and serve as a decoration.

At least a water wheel 702, 709 or air cleaning water wheel 529 is provided on the housing 601. The water wheel 702, 707 or air cleaning water wheel 529 is provided with a shaft 701, 708 or 703 respectively, which in turn can connect with a gear 294 shown in FIG. 14, an eccentric wheel 178 shown in FIG. 24, and eccentric wheel 124 shown in FIG. 16, a conveyor belt (not shown in the drawings), the decoration through a mechanism shown in FIGS. 8-26, 29, and 30, a fan 148 shown in FIG. 13, or directly a decoration.

The water flows continuously out of the water exit 602 and exerts a force against the water wheel 707, 702, or the air-cleaning water wheel 529 so that the shaft 708, 701 or 703 of the water wheel 707, 702, or the air cleaning water wheel 529 respectively rotates, so does the decoration on the shaft 708, 701, or 703, or the mechanisms shown in FIGS. 8-26, 29, 30 and the decoration connected therewith.

On the other way, the water from the water pump 540 can flow through a branch water pipe 717, and exit at a water exit 705 and exert a force directly against the water wheel 702, so that the shaft 701 on the water wheel 702 rotates, so does the decoration on the shaft 701, or the mechanisms shown in FIGS. 8-26, 29, and 30 and the decoration connected therewith.

As shown in FIG. 46, the embodiment can have the visual effects of a waterfall, and has a decorative housing 601, which has a first water exit 602. A water sub-receptacle 503 is provided on the lower part of the housing 601. A filter 530, a bag 553 having ice, air freshener, and/or aromatic material, and an air cleaning device 554 can be provided on the bottom of the water sub-receptacle 503, which also has a water pump 540 which is connected with a first water exit 602 through a water pipe 543. A fan 501 is provided on the housing 601. When the power is turned on, water sub-receptacle 503 is filled with water. The water is pumped by the water pump 540, flows to the water exit 602 through the water pipe 543. Water repeatedly flows from the water exit 602 and creates visual effects of a waterfall, which. can clean the air blown against the waterfall by a fan 501. Therefore, this embodiment can clean the air, humidify the air, and serve as a decoration.

On the other aspect, a water raising device 711 is provided on the housing 601. A plurality of water scoops (cups) 712 are provided on the water raising device 711, which has one end thereof in the water sub-receptacle 503. When the water raising device 711 is rotated by a motor 713 (this motor 713 can also used for rotating the fan 501), or a motor for rotating the fan 501, the scoops 712 are filled with the water in the water sub-receptacle 503 and rises one by one gradually upwardly toward the top of the water raising device 711, then moves downwardly while having the water in the scoops 712 pour downwardly one by one and creates a waterfall continually. This water can rotate the water wheel 702 and shaft 701 in FIG. 45, or the water wheel 529 and shaft 703. Thus, the decorations on the shaft 701 or 703, or the mechanisms shown in FIGS. 8-26, 29, and 30 and the decorations connected therewith also rotate.

At least a flower support 718 is provided with the housing 601 (FIG. 46) for supporting flowers. The flower support 718 is provided with an opening 719. Therefore, the present invention can clean the air, cool the air, and also provide decorations such as waterfalls and flowers. This structure can be used with those shown in FIGS. 8-40.

FIGS. 47-48 show another embodiment of the present invention. At least one water reservoir 603, 604, 605, and/or 606 is provided on the housing. The water reservoirs 603-606 can be of different forms, e.g. a water receptacle as shown in FIG. 27,31-33,45-48. As shown in FIG. 47, a power source 506 (can be a motor or musical box shared with that for the fan) or a motor for the fan can rotate a shaft 507 or a shaft 1316 inside or outside of the water reservoir 603. Another end of the shaft 507, 1316 can be connected with a decoration directly, or through a mechanism shown in FIGS. 8-26. As shown in FIG. 48, there is a decoration 607 which is similar to that decoration 330 shown in FIGS. 10, can be moved by the shaft 507.

Further to the description of the embodiments or the present invention, a water wheel 529 can be provided in the water sub-receptacle 503. When the decorative humidifier is being used, the fan 501 blows wind toward the waterfall(s) so that the air can be cleaned. The wind will blow toward the water wheel 529 as well, so as to enhance the cleaning of the air. The filter 530 can absorb the impurities in the air. The water pump 540 pumps the water to the water exit 602 on top of the housing 601 through the water pipe 543, so that water flows downwardly to fill up the water reservoir 603 first, then fill up the water reservoirs 604, 605, and 606 one by one, then flows into the water sub-receptacle 503. The water reservoirs 603-606 can be used with the mechanisms shown in FIGS. 29-33, to enhance the decorative effects.

The inventor of the present invention also has the following eighteen US patents granted: U.S. Pat. Nos. 5,078,386; 5,088,373; 5,070,753; 5,286,535; 4,890,828; 5,203,743; 4,987,787; 6,978,564, 4,939,944; 5,448,007; 5,081,899; 8,807,539, 9,157,644, 8,371,559, 8,146,892, 8,025,270, 9,151,509 and 5,163,878. These patents can be used with the structures of FIGS. 45-48 of the present invention.

The foregoing description is provided for illustrative purposes only and should not be construed as any way limiting this invention, the scope of which is defined solely by the appended claims.

1. A toy construction element decoration comprising at least one water tank or water reservoir, the toy construction elements comprising couplings releasably interconnecting the toy construction elements.

2. The toy construction element decoration as claim 1: further comprising a pump.

3. The toy construction element decoration as claim 1: further comprising at least a decoration floated in the water receptacle.

4. The toy construction element decoration as claim 1: further comprising an atomization device, Atomization device can be an ultrasonic device or a heater or filter or a water absorption strip or Absorbent tube for transforming water into vapor.

5. The toy construction element decoration as claim 1: further comprising a magnet or magnetic device.

6. The toy construction element decoration as claim 1: further comprising a light illuminates the moving pictures on the decoration so as to produce a visual effect.

7. The toy construction element decoration as claim 1: further comprising a bubble device.

8. The toy construction element decoration as claim 1: further comprising a shaft to move a decoration.

9. The toy construction element decoration as claim 1: further comprising a light

10. A toy construction element decoration comprising an atomization device, the toy construction elements comprising couplings releasably interconnecting the toy construction elements: Atomization device can be an ultrasonic device or a heater or filter or a water absorption strip or Absorbent tube for transforming water into vapor.

11. The toy construction element decoration as claim 10: further comprising a pump.

12. The toy construction element decoration as claim 10: further comprising a magnet or magnetic device.

13. The toy construction element decoration as claim 10: further comprising a dialogue system can be linked with a smartphone or computer or other internet of things.

14. The toy construction element decoration as claim 10: further comprising a speaker or voice device composed of toy construction elements, the toy construction elements comprising couplings releasably interconnecting the toy construction elements. a speaker or voice system can be linked with a smartphone or computer or other internet of things.

15. The toy construction element decoration as claim 10: further comprising a light.

16. The toy construction element decoration as claim 10: further comprising a bubble device.

17. The toy construction element decoration as claim 10: further comprising a shaft to move a decoration.

18. A toy construction element decoration comprising at least one magnet or an magnetic device to move a decoration, the toy construction elements comprising couplings releasably interconnecting the toy construction elements.

19. The toy construction element decoration as claim 18: further comprising at least a decoration floated in the water receptacle.

20. The toy construction element decoration as claim 18: further comprising a shaft.
